(19) United States
(12) Patent Application Publication
(10) Pub. No.: US 2008/0140432 A1
(43) Pub. Date: Jun. 12, 2008

(54) VERIFICATION AND DATA-TRACKING SYSTEMS, METHODS, AND DEVICES

(76) Inventor: Leo E. Fenn, Newport Coast, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/778,621

(22) Filed: Jul. 16, 2007

Related U.S. Application Data
(60) Provisional application No. 60/873,335, filed on Dec. 7, 2006.

(51) Int. Cl. G06Q 99/00

(52) U.S. Cl. 705/1

(57) ABSTRACT

Embodiments of the present disclosure include a system and method for registering and verifying wine or other or other items, such as collectibles. In an embodiment, a collectible item receives a label containing a unique identifier, which may be used to register information about the item with a computer system according to the disclosure. The label may be capable of monitoring specific aspects of the storage and/or handling of the item to give a user an indication of the quality of the item.

### RELATED APPLICATION

This application is related to and claims the benefit of U.S. Provisional Patent Application No. 60/873,335, filed on Dec. 7, 2006, which is incorporated in its entirety by reference herein for all that it discloses.

### BACKGROUND

1. Field of the Disclosure

The field of the present disclosure relates in general to computer systems for the authentication and/or data tracking of products and related methods and devices, and in particular to computer systems for the authentication and/or data tracking of containers and/or contents of containers, such as bottles of wine, and related methods and devices.

2. Description of the Related Art

Wine is a unique collectable product that changes its character and value over time. For example, certain wines can become more or less valuable over time depending on when the wine has “peaked” within the bottle. Also, the quality and value of a wine can change significantly depending on the environment in which it is kept. It is well known, for example, that red wines are sensitive to sunlight and temperature, which can change the character and even spoil the wine if it is exposed to too much of either. For example, if a red wine is maintained above 80 degrees for an appreciable amount of time, the wine will be “cooked” and often rendered undrinkable. At a minimum, the taste of “cooked” wine will likely disappoint the buyer.

In addition, wine, like many collectable items, is subject to potential forgery. However, unlike most other collectable items, the wine itself cannot be authenticated by sampling or inspection. Thus, authentication of a bottle of wine must generally rely on an inspection of the bottle and label, as opening the bottle itself would destroy its value as a collectable item. The changing characteristics of wine as a collectable and consumable item present unique problems for collectors. For example, because collectors can generally only inspect the glass bottle and label rather than the wine itself, it is often difficult for non-professional collectors to know for certain whether a particular bottle is genuine. These limited clues to the genuineness of a bottle of wine can reduce the value of a particular bottle at an auction, particularly where the overall value of the bottle does not justify the expense of a professional appraisal and authentication of the bottle. Additionally, there is limited or no opportunity to return wines purchased at auction to the seller once opened and partially consumed, placing much more of the risk in the hands of the buyer than with many other purchases. For these and other reasons, collectors often pay for wines that they cannot be sure are authentic or that were not maintained in ideal conditions.

Moreover, it is difficult, if not impossible, from even a careful visual inspection to know under what conditions a particular bottle of wine has been maintained, and thus collectors often pay less than what they might pay given perfect knowledge of a bottle and its maintenance. Purchasing conditions may prevent even the most knowledgeable collectors from accurately gauging a bottle's value. For example, internet auctions allow no hands-on inspection and less than ideal conditions for visual inspection. Potential purchasers in these situations generally must rely on such imperfect clues as the reputation of the seller to determine whether a wine is genuine and has been stored in accordance with acceptable limits.

The difficulty in gauging the genuineness and quality of wines or other collectibles offered for sale, usually sight unseen, chronically depresses the price paid for high-end wines at auction to compensate for that uncertainty. Accordingly, there is a need for a system to assist buyers in determining the quality and character of wines or other collectible and/or perishable items.

### SUMMARY

In some embodiments of the present disclosure, fraud is reduced and buyer confidence in the authenticity and value of collectable wines is increased.

In some embodiments, a computer system is provided for registering and tracking bottles of wine. An interactive website can be maintained through which bottles of wine may be registered by an identifier, such as a unique serial number, affixed to the bottle. In some embodiments, this identifier may be affixed to a bottle using a tamperproof sticker. In some embodiments, this sticker may be holographic. A temperature strip or other environmental indicator can be affixed to a bottle of wine to record the highest and/or lowest temperature achieved by the bottle for an appreciable amount of time.

Some embodiments provide a system for registering bottles of wine, each bottle having a label with a unique identifier, and a server capable of accepting and storing data regarding each at least one bottle of wine. In some embodiments, the server is further connected to a communications network, such as the internet, so that the information stored on the server can be accessed remotely.

Embodiments of the present disclosure also include wine bottles labeled for use in systems for registering bottles of wine. The label for use in such a system can include, in some embodiments, an information layer, having a unique identifier on the readable side and having adhesive on the back for attachment to a wine bottle. In various embodiments, the label may include a machine readable portion and/or a human readable portion. In some embodiments, the same label or a different label or region on the bottle may have an environmental indicator, such as, for example, a temperature indicator capable of indicating a maximum or minimum temperature at which the bottle was stored.

The present disclosure also includes methods of registering wine bottles. In some embodiments, the methods include applying a unique label to a wine bottle, the label including a unique identifier, communicating the unique identifier to a server, saving a record containing the unique identifier and information indicative of the wine bottle in a database associated with the server. In some embodiments, the record is further capable of storing indications of changes in data, such that a history of the product can be gathered.

### BRIEF DESCRIPTION OF THE DRAWINGS

The following drawings and the associated descriptions are provided to illustrate embodiments of the present disclosure and do not limit the scope of the claims. Throughout the drawings, reference numbers are re-used to indicate correspondence between referenced elements.

FIG. 1 illustrates an embodiment of a computer system for registering and tracking wines.

FIG. 2A illustrates an embodiment of a bottle of wine having a label.

FIG. 2B illustrates another embodiment of a bottle of wine having a label.

FIG. 3 illustrates a block diagram of an embodiment of a method of registering wines.

FIG. 4 illustrates a block diagram of an embodiment of a method of maintaining and providing wine bottle registration and verification information.

FIGS. 5A-B illustrate representative screenshots for a procedure to register a bottle of wine in accordance with an embodiment of the disclosure.

FIGS. 6A-C illustrate representative screenshots for a procedure for searching and viewing previously registered bottles of wine in accordance with an embodiment of the disclosure.

FIGS. 7A-B illustrate representative screenshots for a procedure for registering multiple bottles of wine simultaneously in accordance with an embodiment of the disclosure.

FIG. 8 illustrates a representative screenshot for amending or updating registered user information in accordance with an embodiment of the disclosure.

### DETAILED DESCRIPTION OF SPECIFIC EMBODIMENTS

Embodiments of the present disclosure can be used in many contexts. An example of some embodiments of the disclosure in usage by an auction house is provided for illustration. It is common for auction houses or individuals to auction off certain bottles of wine during a live, in person auction, while some other bottles may be auctioned off through the auction house's internet site. In order to command top prices for the wines, the auction house may have each bottle appraised by an expert. Each bottle may then be sold with some degree of confidence as to the authenticity of the wine. However, the expense of the appraisal can be cost prohibitive for some lesser-valued wines.

In accordance with some embodiments of the present disclosure, special labels may be affixed by a winery, wine bottle seller, or the auction house, for example. These labels can have a unique identifier for the bottle or a special maximum temperature indicator. The maximum temperature indicator preferably has an irreversible indication of a maximum and/or minimum temperature, such that any bottle of wine with an indication higher than, for example, 80° F. is known to have been stored improperly.

The bottle can be registered, via the unique identifier, on a web site. The registration may contain such information as: the unique identifier, the winery, the type, the vintage, the total number of bottles of that type and vintage, and/or any of a number of other characteristics. Once the auction house comes into possession of any of these bottles, it can check the maximum temperature indicator to help ensure that the bottle has been stored properly throughout its life span. Additionally, it may register that it has become the owner of the bottles by itself logging onto the web site and updating the entry containing the unique identifier. Viewing the history of the wine and checking the label of the bottles against the information stored on the website can help ensure that the bottle is genuine. In cases where the winery has affixed the labels and begun the registry, the auction house can minimize the need for an expensive expert appraisal; in some cases, this appraisal may be avoided entirely. If a history is maintained of various users and conditions of the bottle, it may also be easier to detect fakes or forgeries. For example, if the history maintains information on the maximum temperature reached for a given bottle, the number should never decrease. A decrease in this number at a certain time may indicate that the temperature indicator was altered or that the labeled bottle is not the same.

Additionally, users may add unique labels and register the wines that do not already have labels in accordance with certain embodiments of the present disclosure. While this may not provide a complete history of a bottle, it may still reduce costs for further appraisals and begin a value-added history for the bottle. Adding these labels and/or the registration service may also increase the future resale value for any owner, who can indicate the conditions in which the bottle was kept during his or her ownership and register any information of the history of the bottle that he or she knows.

The disclosure is not limited to use in auctions or by auction houses. Rather, embodiments of the disclosure can be used or applied in many other contexts, including sales or transfers by manufacturers, retailers, and distributors, and sales or transfers by and among collectors and/or consumers.

In some embodiments, the various features and functions described in this document may be embodied in software modules executed by one or more general purpose computing devices. The modules may be stored in any type of computer readable storage medium or device. Systems and methods which represent various embodiments and example applications of the present disclosure will now be described with reference to the drawings. Corresponding numbering indicates corresponding parts, and the leading digit indicates the figure in which an element first appears.

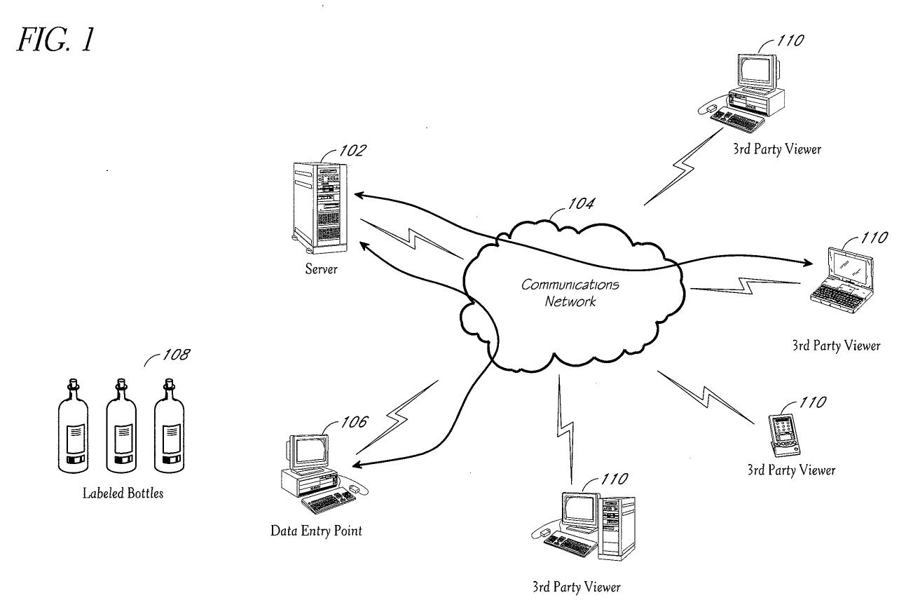

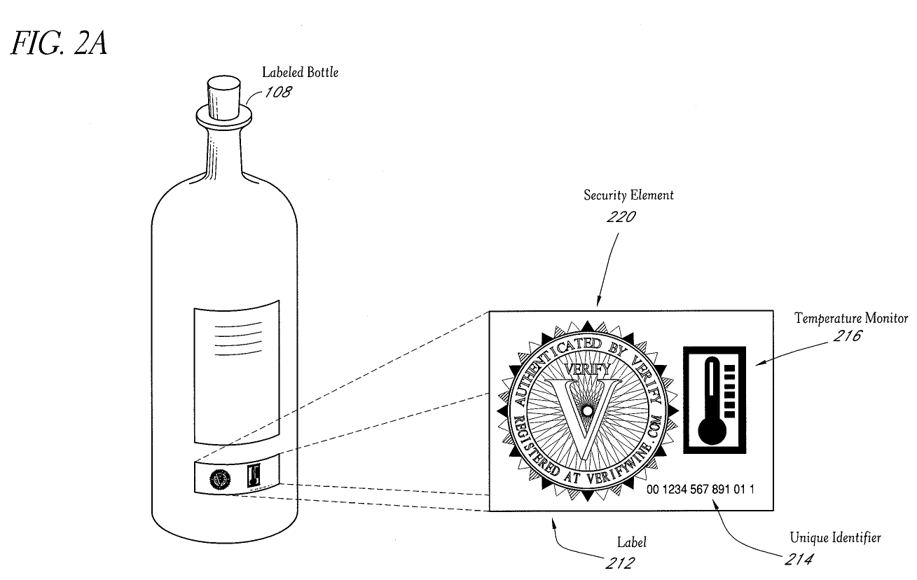

As shown in FIG. 1, some embodiments of an authentication and/or data tracking system involve registering bottles of wine through a computer system. As used herein, the term “bottle” can also apply to any container and also to its contents, such as a beverage, as the context permits. Also, any reference to “wine” can also apply to other container contents, such as other beverages or other substances.

A user who has come into possession of or become aware of information relating to a particular bottle of wine 108 may wish to register it or provide data about it using a data entry point 106 in some embodiments of the system. The user may obtain a label 212 and affix it to the bottle (block 330). In some embodiments, the bottle 108 may have an identifier associated with it by some other means, including features printed on or manufactured in the bottle 108 or other container, or electronic components attached to or embedded in the bottle or other container.

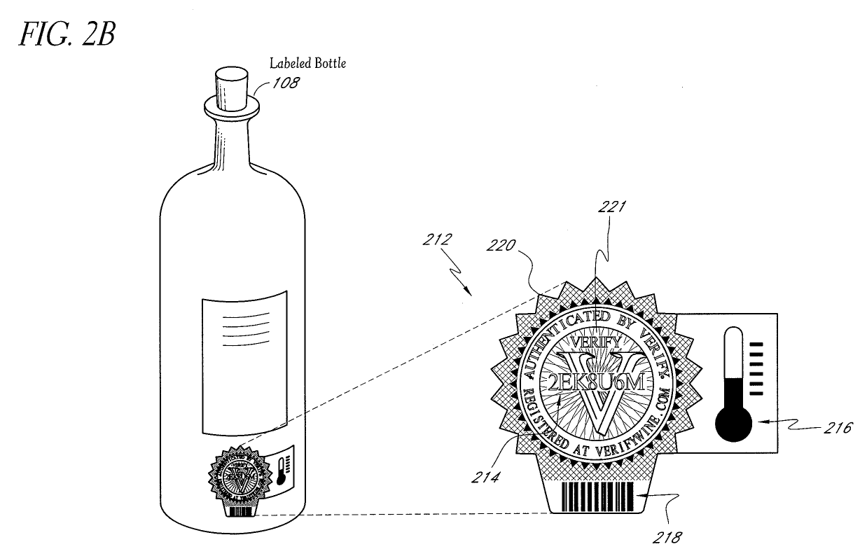

Turning to FIGS. 2A and 2B, a labeled bottle 108 according to some embodiments is schematically shown. Labeled bottle 108 includes a special label 212. This label 212 may have a variety of different elements in many embodiments. In some embodiments, the label 212 includes a unique identifier 214. This unique identifier 214 may allow each bottle to be separately registered with the computer system of FIG. 1 with a reduction or elimination of confusion between various bottles of the same vintage, type, or even the same original case.

In some embodiments, the label 212 includes a temperature monitor 216. The temperature monitor 216 is preferably an indicator, such as an irreversible indicator, of the maximum and/or minimum temperature to which the indicator has been subjected. The temperature monitor may be similar or identical to those commercially available from Thermographic Measurements Ltd. (TMC) (http://www.t-m-c.com/index.html) and marketed under the trade name Thermax. In addition or as an alternative to a character-based unique identifier 214, a label 212 may include a bar code or other computer-readable information 218, in some embodiments such as shown in FIG. 2B. In such embodiments, the machine-readable element 218 can be unique to the specific labeled bottle 108 and may act as a quick way to identify a bottle using a computer system of the present disclosure, such as if a data entry point 106 includes a bar code reader. It should be noted that a standard UPC Bar Code will not accomplish this task, because a UPC Bar Code only designates a type of product. A UPC Bar Code designates a manufacturer and product and package type, such as for example, a 2 liter bottle of Coca-Colas Classic. Each bottle has the same UPC Bar Code, however, and one 2 liter bottle cannot be distinguished from another. In contrast, the systems and methods contemplated herein provide identification such that every individual bottle or package would be distinguishable from others of the same type.

Additionally, in some embodiments, a label 212 preferably includes tamper resistant and/or copy resistant features, as indicated by security element 220. Security Elements 220 may be visible or hidden and may be included in or on any portion of a label 212. Visible features of security element 220 may include holograms 221, such as labels available from Nova Vision, Inc. (http://www.novavisioninc.com/).

Hidden security elements 220 may include special printing and/or special adhesives that reduce the ability to remove and reapply a label. Preferably the labels 212 are constructed such that they cannot be peeled off or otherwise easily removed from the bottle without being destroyed or demonstrating clues that indicate tampering. For example, a security element 220 may be a multi-layered label with adhesives that help allow separation of the label's layers should someone attempt to remove the label. Examples of features such as these are also available from Nova Vision, Inc. Each of these features can aid in providing more certainty of the authenticity of a bottle. The labels 212 may be affixed by the wine manufacturer upon the release and sale of the bottles to the public, by an appraiser or by the current owner of the wine, for example.

In a preferred embodiment shown in FIG. 2B, a label 212 includes a unique identifier 214 printed on or as a part of a holographic surface 221, a specific visible security element 220. The label 212 also includes a bar code 218 that corresponds to the unique identifier 214. In a preferred embodiment, the label surface as whole comprises a further security element 220 in the form of a tamper evident release dot pattern. This means that once a label is affixed to a surface, removing the label will leave a dot pattern on the surface while the label will show visible evidence of the dots having been left on the surface during removal. A further security element 220 present in a preferred embodiment is microtext in the holographic surface 221. The microtext is readable with magnification, but is more difficult to reproduce and counterfeit. Finally, in a preferred embodiment, the labels 212 will have security tag-ins, which are special particles that provide a sort of signature able to be detected by a special machine reader. These particles are generally microscopic and very hard to detect or match.

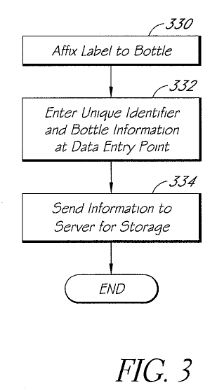

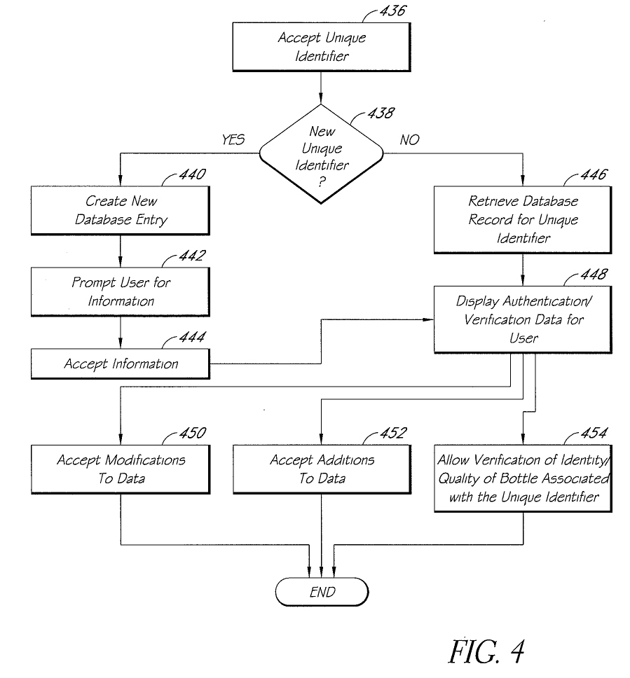

As shown in FIG. 3, the user may then use data entry point 106 to convey or receive data associated with the bottle of wine. The user may, for example, enter information about the wine to associate with the unique identifier such as, for example: the name of the winery or manufacturer, the year produced, the type of wine or other contents, the name and address of the owner of the bottle, the location where the bottle is kept, whether the bottle has been authenticated by a professional appraiser, any special characteristics or distinguishing marks or other features on the bottle, the existence of a temperature sensing system affixed to the bottle, and/or, if present the maximum or minimum temperature reading yet recorded.

In some embodiments, the foregoing information, as well as additional information relevant to the quality and/or history of the bottle of wine may be entered by the user by way of a data entry point 106 and stored in server 102 for future access, review, alteration, etc. This may involve accessing an interactive website available from the server 102. Upon accessing the server 102, the user may input the unique identifier 214. In various embodiments, a user may be an individual owner of a bottle, a website operator having received information from the owner, or a wine appraiser, for example.

In some embodiments, a user at a data entry point 106 is one in possession of or aware of one or more of the wine bottles 108, which may in some embodiments have special labels. In some embodiments, any number of third party viewers 110 may also access server 102 through communications network 104 to review wine bottle data. In another embodiment, server 102 may also be integrated with auction features such that third party viewers 110 may view registered bottles that are up for auction, review the history of the bottles, and place bids as desired.

Suitable hardware for a data entry point 106 and/or a third party viewer 110 of a wine registry system as discussed herein includes a conventional general purpose single-chip or multi-chip microprocessor such as a Pentium® processor, a Pentium® II processor, a Pentium® Pro processor, an xx86 processor, an 8051 processor, a MIPS® processor, a Power PC® processor, a SPARC® processor, an ALPHA® processor, or other processor known to one in the art, such as those available from Intel, Advanced Micro Devices, etc. In addition, the microprocessor may be any conventional special purpose microprocessor such as a digital signal processor. Furthermore, the server 102 may be used in connection with various operating systems such as: Microsoft Windows® 3.x, Microsoft® Windows 95, Microsoft® Windows 98, Microsoft® Windows NT, Microsoft® Windows XP, Microsoft® Windows CE, Palm Pilot OS, OS/2, Apple® MacOS®, Apple® OS X, Disk Operating System (DOS), UNIX, Linux®, VxWorks, IBM® OS/2, Sun OS, Solaris OS, IRIX OS operating systems, and so forth. In some embodiments, a data entry point 106 or a third party viewer 110 may also include or communicate with a network interface module to facilitate communication between it and server 102.

In many embodiments, data entry points 106 and third party viewers 110 may include the same or similar hardware and/or software. In some embodiments, data entry points 106 and third party viewers 110 are preferably web-enabled computers, such as personal computers or Apple computers, workstations, terminals, and the like. Such a device will likely have a browser module that uses text, graphics, audio, video, and/or other media to present data and to allow interaction with data via the communications network 104. The browser module may be implemented as a combination of an all points addressable display such as a cathode-ray tube (CRT), a liquid crystal display (LCD), a plasma display, or other types or combinations of displays. In addition, the browser module may be implemented to communicate with input devices and may also include software with the appropriate interfaces which allow a user to access data through the use of stylized screen elements such as, for example, menus, windows, dialog boxes, toolbars, and controls (e.g. radio buttons, check boxes, sliding scales, etc.). Furthermore, the browser module may communicate with a set of input and output devices to receive signals from a user. The input device(s) may include a keyboard, roller ball, pen and stylus, mouse, trackball, voice recognition system, or pre-designated or software designated switches or buttons. The out put device(s) may include a speaker, a display screen, a printer, or a voice synthesizer. In addition, a touch screen may act as a hybrid input/output device. In another embodiment, a user may interact with the system more directly such as through a system terminal connected to the server 102 without communications over the Internet or other wide area network.

In some embodiments, a data entry point 106 or a third party viewer 110 is a personal computer, a laptop computer, a Blackberry® device, a portable computing device, a server, a computer workstation, a local area network of individual computers, an interactive kiosk, a personal digital assistant, an interactive wireless communications device, a handheld computer, an embedded computing device, a cellular or mobile telephone, a personal gaming device, or the like.

In some embodiments, data entry point 106 may also include or interact with an input device capable of reading bar codes, interacting with radio frequency identification (RF ID) tags, or the like. In such embodiments, label 212 can include a machine-readable identifier 214, such as a bar code or RF ID tag, indicative of the unique identifier 214. This may allow easier input of data about a particular labeled bottle 108, as a user may not need to manually input an identifier 214. In some embodiments, a bar code or other machine-readable identifier 218 may replace a human readable unique identifier 214, but it is preferable to include a human readable unique identifier 214 so that specialized equipment, such as a bar code reader is not required for interaction with the system.

FIG. 4 identifies one method of the server 102 interacting with a data entry point 106 and/or a third party viewer 110. In some embodiments, server 102 accepts entry of a unique identifier 214 for look-up (block 436). This may be done utilizing one or both of the unique identifier 214 and the machine-readable identifier 218. If this is an unrecognized or new unique identifier 214, the server 440 creates a new database record to store information associated with the new unique identifier (block 440). In some embodiments, server 102 then prompts data entry point 106 for information to associate with the unique identifier, such as the information listed above (block 442). Server 102 then accepts entered information and stores it in the database record (block 44). In some embodiments, this information may be verified before storage, either through automated checking against acceptable values or through prompting a user to confirm the accuracy of entered information. Once the information has been entered and accepted initially, the server 102 may display that information to the initial user (block 448). Additionally, the user who entered the information at data entry point 106 or another user may be able to modify or add to the data (blocks 450, 452). For example, the storage conditions may have changed, and temperature monitor 216 may have read differently than originally input to the system. In some embodiments, the server 102 is capable of accepting that change and updating the database record.

The communications between and among the data entry points 106, third party viewers 110, and/or server 102 may be performed over a local or wide area distributed network, such as the internet. In some embodiments, a global system utilizes the World Wide Web and provides for interaction through suitable web pages. As shown in FIG. 1, the system may utilize a server 102 connected to a communications network 104, such as the internet. In various embodiments, the communications network 104 may include one or more of the following: a LAN, a WAN, the internet, a wireless network, a satellite network, a Bluetooth® network, a cellular or mobile phone network, combinations of the same, and the like. Such communications may occur through standard telephone lines, DSL lines, cable lines, T1, T3, OC3, OC12 lines, and the like, as well as radio frequency, satellite or other wireless communications, and the like.

Suitable hardware for a server 102 of a wine registry system as discussed herein includes a conventional general purpose single-chip or multi-chip microprocessor such as a Pentium® processor, a Pentium® II processor, a Pentium® Pro processor, an xx86 processor, an 8051 processor, a MIPS® processor, a Power PC® processor, a SPARC® processor, an ALPHA® processor, or other processor known to one in the art, such as those available from Intel, Advanced Micro Devices, and the like. In addition, the microprocessor may be any conventional special purpose microprocessor such as a digital signal processor. Furthermore, the server 102 may be used in connection with various operating systems such as: Microsoft Windows® 3.x, Microsoft® Windows 95, Microsoft® Windows 98, Microsoft® Windows NT, Microsoft® Windows XP, Microsoft® Windows CE, Palm Pilot OS, OS/2, Apple® MacOS®, Apple® OS X, Disk Operating System (DOS), UNIX, Linux®, VxWorks, IBM® OS/2, Sun OS, Solaris OS, IRIX OS operating systems, and so forth. In some embodiments, server 102 includes or communicates with a network interface module to facilitate communication between it and data entry points 106 and third party viewers 110 through communications network 104.

In some embodiments, server 102 is a web-enabled computer, such as a personal computer an Apple computer, a blade server, a workstation, terminal, or the like. The server 102 may or may not have various attached input and output devices. A server 102 may include an all points addressable display such as a cathode-ray tube (CRT), a liquid crystal display (LCD), a plasma display, or other types or combinations of displays. In addition, the server 102 may be implemented to communicate with input devices and may also include software with the appropriate interfaces which allow a user to access data through the use of stylized screen elements such as, for example, menus, windows, dialog boxes, toolbars, and controls (e.g. radio buttons, check boxes, sliding scales, etc.). Furthermore, the server 102 may communicate with a set of input and output devices to receive signals from a user. For example, the input device(s) may include a keyboard, roller ball, pen and stylus, mouse, trackball, voice recognition system, or pre-designated or software designated switches or buttons; the out put device(s) may include a speaker, a display screen, a printer, or a voice synthesizer. In addition, a touch screen may act as a hybrid input/output device.

In some embodiment, a server 102 is a personal computer, a laptop computer, a Blackberry® device, a portable computing device, a server, a computer workstation, a local area network of individual computers, an interactive kiosk, a personal digital assistant, an interactive wireless communications device, a handheld computer, an embedded computing device, a cellular or mobile telephone, a personal gaming device, etc.

In some embodiments, server 102 is a web server capable of providing web pages to requesting computers. Such a server may utilize the Hypertext Transfer Protocol (HTTP), secure HTTP (HTTPS), or other suitable transfer protocol to provide its web pages. Suitable web pages may be written in the Hypertext Markup Language (HTML) and/or include active server pages, scripts, Java® applets, and the like. In some embodiments, server 102 handles content including plug-ins like Flash and Shockwave. Many other variations can also be used. For example, a data entry point 106 may communicate with server 102 through communications network 104 or a data entry point 106 may communicate directly with server 102.

In some embodiments, a server 102 includes a database capable of storing records relating to bottles of wine. Each record entry is preferably indexed and/or accessible by the unique identifier 214, and is capable of storing information associated with the bottle as entered by a user, such as through the data entry point 108 via a web-based interface provided by some embodiments of server 102. In some embodiment, suitable storage, such as a database, is resident on separate hardware in communication with server 102.

In some embodiments, a server 102 may include or communicate with a sales or auction module. A sales module may allow for display, sale, and/or purchase of particular bottles or containers registered according to an embodiment of the disclosure. Similarly an auction module can be capable of displaying available items, accepting bids, and tracking the winning bidder. In these configurations, a third party viewer 110 may interact with a server 102 according to the present disclosure.

When a bottle of wine is sold or transferred to another owner, or even moved to a new location, the database record stored on server 102 may be updated to indicate any changes in ownership, condition, and the like. For example, in some embodiments, a new user may utilize a different data entry point 106 to input the unique identifier from a bottle he recently purchased (block 436). In some embodiments, if information about the bottle has already been stored (block 436), the server will retrieve the database record associated therewith (block 446) and display it (block 448). The new user may then be able to submit modifications to the data (block 450), submit additions to the data (452), and/or verify that the bottle he just purchased is, in fact, a genuine bottle or if the original user had tampered with the bottle or otherwise provided an incorrect bottle (block 454). For example, a new user may be able to modify data such as the maximum temperature reached by the temperature monitor 216. The user may be able to add his or her personal information as the new owner. In this way, the pedigree or owner history of each bottle may be tracked continuously from owner to owner over time. Alternatively, in some embodiments, the temperature indicator may be tracked over time by adding information to the record rather than modifying it. In some embodiments, a first user may be restricted to only modifying his or her information, while other users may add additional information but not modify the first user's information.

In some embodiments, certain information, such as personally identifying information may be accessible only to certain individuals or groups to help reduce the dissemination of private information. For example, an individual who uses the website may allow only auction houses or wine appraisers to view his or her information. This may allow appraisers to confirm the accuracy of records while reducing the access to an individual's name and address by other wine owners. In some embodiments, personally identifiable information may be restricted to the user, a user-defined group, a predefined group, all users of a certain registered status, and the like.

The server 102 may also be accessible to third party viewers 110 who visit the website. Such users may be able to enter the unique identifier 214 of a bottle 108 to access the registration history of the bottle (block 436). In some embodiments, users may be able to browse and/or search the histories of numerous bottles without needing to know the unique identifier 214. Thus, when purchasing a bottle of wine at an auction, from a dealer, or over the internet, a third party viewer may simply enter the unique identifier 214 of the bottle 108 that he or she is interested in purchasing in order to learn when the bottle was first registered, purchase histories, identifying characteristics, etc. (block path 446 to 448 to 454). A potential purchaser may thus have additional information about the authenticity or other features of the bottle to be purchased, advantageously reducing the uncertainty as to the authenticity or quality of the bottle.

In addition to individual registration, in some embodiments, bottles may be sent to the operator of server 102 or to a third party authenticator, who can provide authentication services and, in some embodiments, may have special access to the disclosed system to note general or specialized information in the bottle record. For example, in some embodiments, server 102 has one or more special log-ins and passwords for approved authenticators, who may be given the ability to enter their verification and appraisal in special fields accessible only to that authenticator. The system may thus be able to help ensure the integrity of an appraiser's opinion separate from a typical user, such as a current or future owner of the bottle 108.

For example, in some embodiments, an authenticator can note his or her professional opinion as to the authenticity and condition of a bottle that will be associated with the bottle's unique identifier 214 and that opinion may become unchangeable by anyone other than the authenticator herself. Similarly, in some embodiments, if a third party authenticator determines that a bottle is a fake, he or she will have the opportunity to note that opinion in connection with the bottle such that future potential purchasers of the bottle may enter the unique identifier 214 from the label 212 into the system and be apprised of that information before making a purchasing decision. Conversely, if an appraiser finds a bottle 108 to be genuine, the appraiser can also log that information and the date of the appraisal for the benefit of future purchasers who can approach a purchase of the bottle with valuable additional certainty as to its authenticity.

Returning now to FIG. 2, additional features of some embodiments of the disclosure relating to labeling, security, and tracking of the conditions in which bottles of wine are kept will be discussed in further detail. Labels 212 may comprise both a unique identifier 214 and a temperature monitor 216 or one or the other. A label 212 may include a machine-readable code 218 and a data entry point 106 may include a bar code reader.

Labels 212 may also include security features to reduce the ability of altering or copying a label 212, removing the label 212 and placing it on a different bottle, and the like. In some instances, this may be accomplished by incorporating holograms into the labels. In some embodiments, label 212 may comprise multiple layers that separate during tampering so that a label is either more difficult or impossible to reapply and/or is visually changed to indicate that the sticker was removed and reapplied. A machine readable aspect of the label, such as a machine-readable code 218 may also make it more difficult to copy or alter a label.

Apart from a bar code, in some embodiments, a radio frequency identification (RF ID) tag or label may be incorporated into label 212. RF ID labels and readers are commercially available from sources such as SimplyRFID, Inc. (http://www.simplyrfid.com) and Symbol Technologies, Inc. (http://www.symbol.com). An RF ID tag may have numerous benefits for both security and ease of data entry. An RF ID tag typically stores a unique identifier that can be read by an RF ID reader. An RF ID tag will likely be more difficult to copy, in turn making the label 212 more difficult to copy or otherwise tamper with. Additionally, a data entry point 106 may include an RF ID reader to facilitate data entry into embodiments of a wine registration system by a bottle owner.

As previously stated, the conditions in which wine bottles are stored or transported may be of interest to prospective buyers or users. For example, red wines are preferably maintained at a specific target temperature such as 57° F. If the wine is maintained at a significantly greater temperature for an appreciable amount of time, the quality and taste of the wine will typically degrade accordingly. Even if the wine is later cooled to an appropriate temperature, the wine will not regain its character and taste. Because it is difficult, if not impossible, to know at what temperatures the wine has been maintained over its lifetime, potential purchasers may be naturally wary of a wine's quality, thereby depressing the purchase price. Some embodiments of the label 212 in accordance with the present disclosure provide additional certainty as to the environmental conditions a wine was subjected to by providing an environmental monitor, such as temperature monitor 216. Such a monitor 216 is preferably an adhesively attached, tamper-resistant, non-removable temperature strip that may be affixed to the bottle 108. Generally, a temperature strip will change color depending on its temperature, but any other suitable method of indicating temperature can be used as well. Preferably, the temperature monitor 216 will record the highest temperature achieved for an appreciable amount of time by the bottle 108 and display that information to an observer. Additionally it is preferable that this indication of maximum temperature be irreversible, such that an attempt to tamper with the temperature monitor 216 to show a lower than maximum temperature is difficult if not impossible without showing signs of the tampering. The temperature monitor 216 may indicate a range of temperatures per gradation, such as a five or ten degree range. Small ranges are generally preferred to provide more accurate readings. In additional embodiments, a temperature monitor 216 may instead or additionally record the minimum temperature that a bottle reaches. For example, a temperature monitor 216 may indicate if a bottle has ever been stored in freezing conditions that might affect the wine, the bottle, its cork, and/or its seal.

For example, in some embodiments, if a wine is maintained in a refrigerator at 57° F. from the date the temperature sensor strip is first affixed to the bottle 108, the temperature monitor 216 will register approximately 57° F. or an inclusive range, such as 55-60° F. If that same bottle is later left out to stand at a room temperature of 70° F. for an appreciable amount of time, the temperature strip will then register 70° F. In some embodiments, if the bottle 108 is returned to the refrigerator at 57° F., the monitor 216 will preferably continue to register 70° F., even if the temperature is substantially reduced. If the bottle 108 is then taken out again and left in a hotter environment at 85° F. for an appreciable amount of time, the monitor 216 will register 85° F. and will continue to register that temperature, even if the storage temperature is later reduced. Wine buyers seeing such a high temperature may then avoid such a bottle or offer a price in accordance with the risk of getting a “cooked” wine. Similarly buyers seeing a temperature indicator of 60° F. on an otherwise identical bottle may pay significantly more.

The temperature monitor 216 may also be designed to indicate specific temperature thresholds, such as, for example, changing color if 80° F. or greater is reached. In such embodiments, the monitor 216 may be designed to permanently change color if the temperature exceeds the predetermined threshold, thereby indicating the undesirability of the wine to future purchasers.

The temperature monitor 216 will also be preferably time delayed such that it will not immediately register the current temperature of the monitor 216 but will register a new higher temperature when the bottle 108 has been exposed to the higher temperature for a length of time, preferably time sufficient for the core temperature of the wine in the bottle 108 to have also reached that temperature. For example, if a bottle maintained at the proper temperature is taken to an area with a higher temperature for a short time, the temperature monitor 216 itself may be exposed to the higher temperature even thought the wine in the bottle will take much longer to reach that critical temperature. The time delay for the monitor 216 to register the higher temperature is preferably set based on the amount of time it would take the core temperature of the wine in the bottle to reach the increased temperature using principles of thermodynamics and based on properties such as those of the bottled wine, the temperature differential, and the insulative properties of the glass bottle.

The temperature monitor 216 information can be a valuable resource to a potential purchaser because it provides additional information about the conditions in which the bottle 108 has been kept that may not be apparent from a visual inspection of the bottle itself.

The temperature monitor 216 information may also be integrated into the computer-based wine registration system described herein to provide even greater information to a potential purchaser. In various embodiments, the temperature monitor 216 and the unique identifier 214 may be on the same or different labels 212 and/or locations, but preferably both are present on a bottle 108. Information about the temperature monitor 216 may also be entered into the server's 102 database when the bottle 108 is registered. For example, the bottle record stored on server 102 can include a field in which the existence of the temperature strip on the bottle is recorded; similarly a maximum experienced temperature of the monitor 216 may be recorded if present on the associated bottle 108. A potential purchaser viewing this information will thus have added security that the bottle 108 he or she intends to purchase has been properly maintained. Similarly, if, upon receipt, a bottle 108 shows a significantly greater temperature, the purchaser may have valuable information aiding in returning the bottle 108 to the seller for a refund or in seeking compensation from the transportation company. In an embodiment, other environmental conditions may be similarly monitored, such as humidity, pressure, and the like.

If label 212 is scraped off by a seller attempting to hide the fact that a bottle 108 was improperly maintained, a purchaser may refer to the registration information for the bottle 108's unique identifier 214 and realize that the bottle was tampered with. In a preferred embodiment, the temperature monitor 216 is included on the same label 212 as a unique identifier 214 such that the monitor 216 cannot be later affixed to a registered bottle without showing a different or alternative unique identifier 214. This helps prevent the owner of a “cooked” wine from obtaining another temperature monitor 216 and affixing it to the bottle after the wine has been returned to an appropriate temperature.

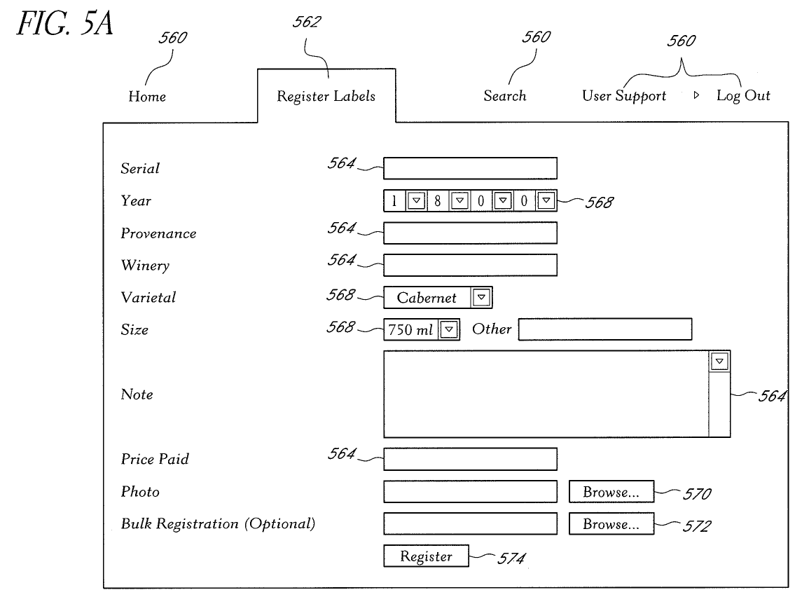

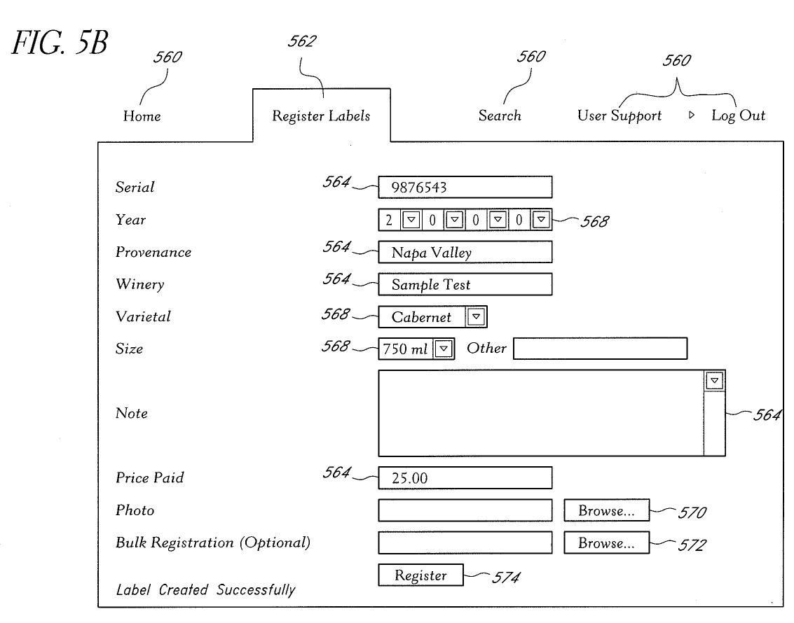

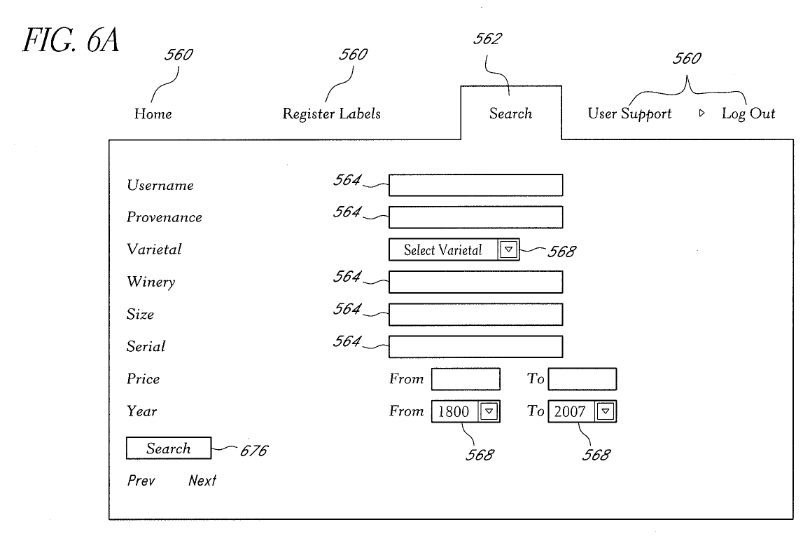

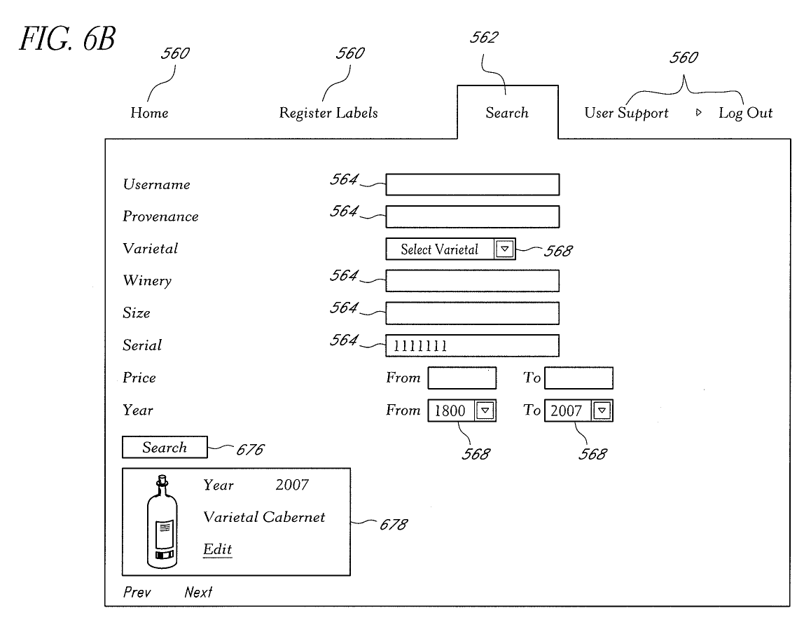

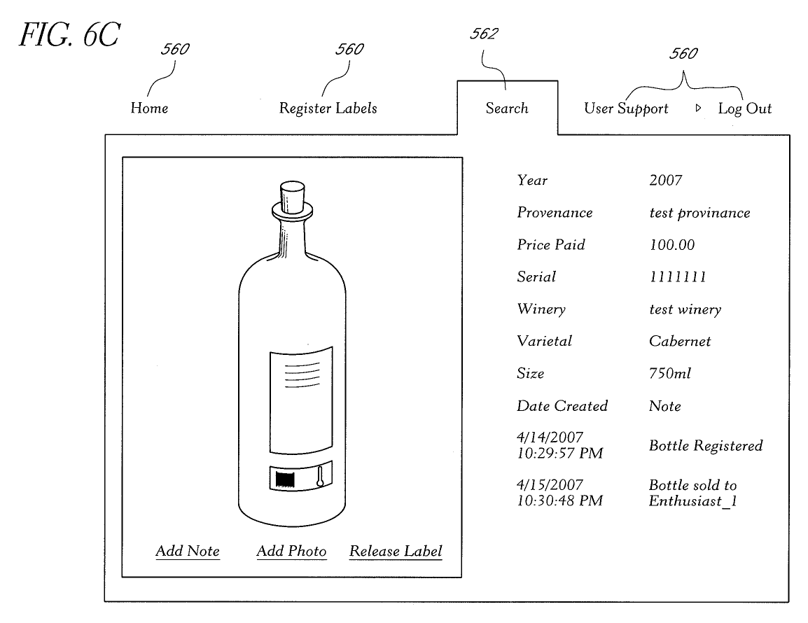

Turning to FIGS. 5A-B, 6A-C, 7A-B, and 8, these figures are representative screenshots from a website or an application, a plug-in, or other type of software and reflect features of some embodiments. FIGS. 5A-B illustrate an example of a procedure for registering a bottle of wine. First, it is preferable for a web-site or application to control user access; for example, a login screen may be represented for entry of an id and password. Preferably only registered users of a website can register, import, or alter information about a bottle of wine. In an embodiment, this may not be required for retrieving information about a previously registered bottle. Once a user enters a login and password, the user may be directed to a “home” page with general information about the application, specific links to the user's previously registered items, and/or other information. As shown in FIGS. 5A-8, in an embodiment, an application or web-site may utilize a “tabbed” look and feel, with background tabs 560 and foreground tab 562-alternatively buttons, links, or the like may be used in place of tabs-to “register labels,” “search,” get “user support,” and the like (see e.g. FIG. 5A). For example, in an embodiment, a user may click on the “register labels” tab to bring up a screen as shown in FIG. 5A. In FIG. 5A, a “Register Labels” screen is shown with its tab as foreground tab 562, while other screen options, such as “Home” and “Search,” are background tabs 560. At this point in some embodiments, a user may enter information about the bottle of wine, such as the serial number for the label he or she wishes to register, the year of the wine, the provenance, the winery, the varietal, and/or the size, as shown in the FIG. 5B example. As shown in FIGS. 5A and 5B, information may be entered in text boxes 564 and pull down menus 568. It is understood that any of a number of data entry techniques, such as text boxes, pull down menus, radio buttons, check boxes, and the like may be used in various examples. This is an example of step 332 in FIG. 3. Additionally, notes about the wine and the price paid may be entered. Any of this information, such as the notes and price paid, may be optional during the registration process. Once the information is entered, clicking the register button 574 sends the information to the server 102 (FIG. 3 block 334). In an embodiment, a screen similar to that pictured in FIG. 6C may be displayed such as to allow confirmation of the data entered and/or confirm that a bottle was registered with the information provided.

As shown in FIGS. 5A and 5B, a photo of the bottle or unique, identifying aspects of a bottle may be uploaded by clicking on the “Browse” button 570 across from the Photo prompt or typing in the location of a file in the box 564 provided. As shown in this embodiment, this screen may have an option to upload a file for bulk registration, such as may be done by a winery (for example, button 572). This may permit the registration of a large number of bottles from a file or files previously assembled on the user's computer, avoiding duplicate data input, saving time, and allowing information to be available for retrieval sooner. For example, one or more files from a winery's inventory management system may be accessible to import registration information. In various embodiments differing file types may be supported, such as, for example, a comma-delineated spreadsheet or an ordinary or specially formatted text file. In some embodiments, this bulk registration upload capability may allow automatic processing by the disclosed system. In other embodiments, the file may be submitted to a system administrator to enter for the user.

FIGS. 6A-C illustrate another aspect of a representative website, application, or other type of software—searching registered items. As mentioned above, in various embodiments, either with or without logging in, a user may click a search tab to bring up a screen as shown in the example of FIG. 6A. In the representative embodiment shown, a user may search by user name, wine provenance, varietal, winery, bottle size, serial number, price range, and/or year. Once the desired information is entered, in the example shown, a user may click on button 676 to retrieve search results. FIG. 6B illustrates the search results on a search for serial No. 1,111,111. As shown, in some embodiments, the search results may be displayed in “thumbnails” 678 or abbreviated format for further selection by a user.

FIG. 6C illustrates an expanded view of the complete record for serial no. 1,111,111, as may be accessed, for example, by clicking on the thumbnail 678 shown in FIG. 6B. A user may also update the record, such as by adding notes and/or photos (such as by clicking on links shown below the picture). In an embodiment, such additions are preferably only allowed by registered users who have passed a log-in process. In some embodiments, records may include current and/or historic ownership records and may include names and locations. Historic ownership records may be reported in complete or partial ownership chains. Information such as this may enhance the value of the bottle, such as if, for example, the bottle was once owned by a celebrity, historical figure, or the like. In an embodiment, information such as ownership by a celebrity or historical figure may have authentication information associated with it. In various embodiments those who view records, such as those shown in FIG. 6C, may see different levels of information based on their registration, bottle ownership, or other status. For example, as shown here, a user may only be able to see the user ID of a bottle purchaser, here “Enthusiast_{—}1.” Some other user may be able to retrieve additional information, such as, in continuing the example, Enthusiast_1's real name and/or contact information.

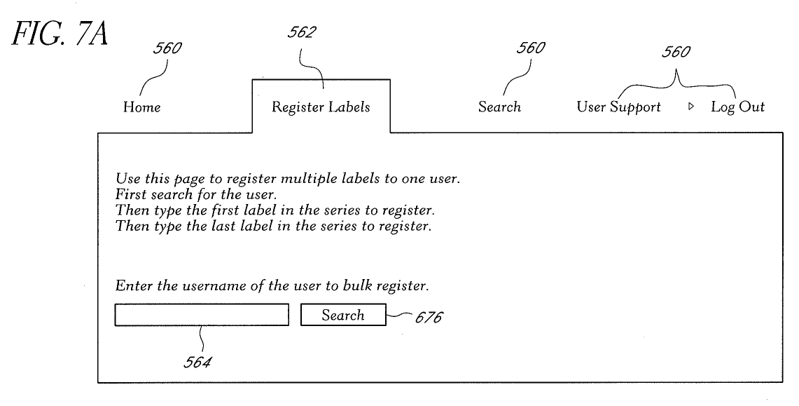

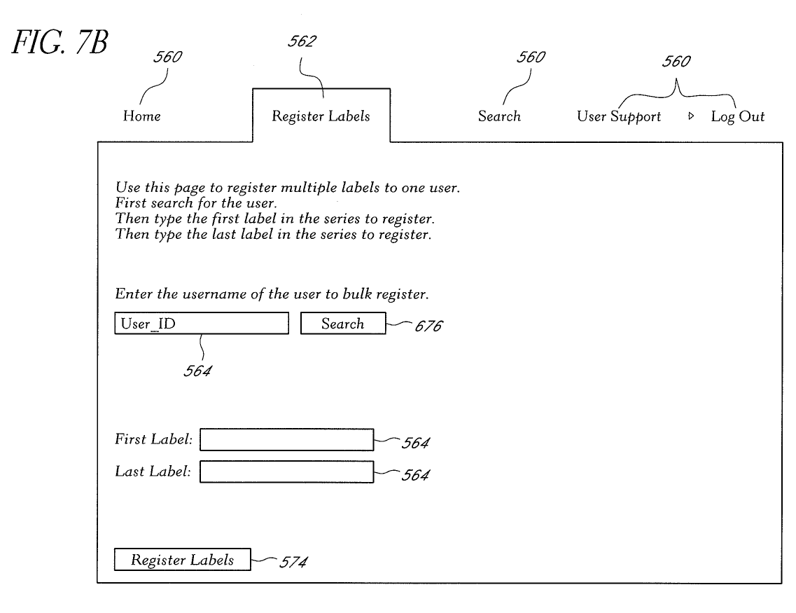

FIGS. 7A-B illustrate an alternative to the bulk registration options discussed above in connection with FIGS. 5A and 5B. First, a username can be entered (such as in text box 564 in FIG. 7A). Then the first and last serial numbers in a range can be entered (FIG. 7B). In an embodiment, options similar to those in FIG. 6A may be entered for the entire range of labels to be registered. Additionally, or alternatively, each label range may then be customized, such as by adding individual pictures or notes. In various embodiments, other or additional procedures may also be used for bulk processing. For example, files may be imported from a spreadsheet program or other external software to complete missing information for the label range.

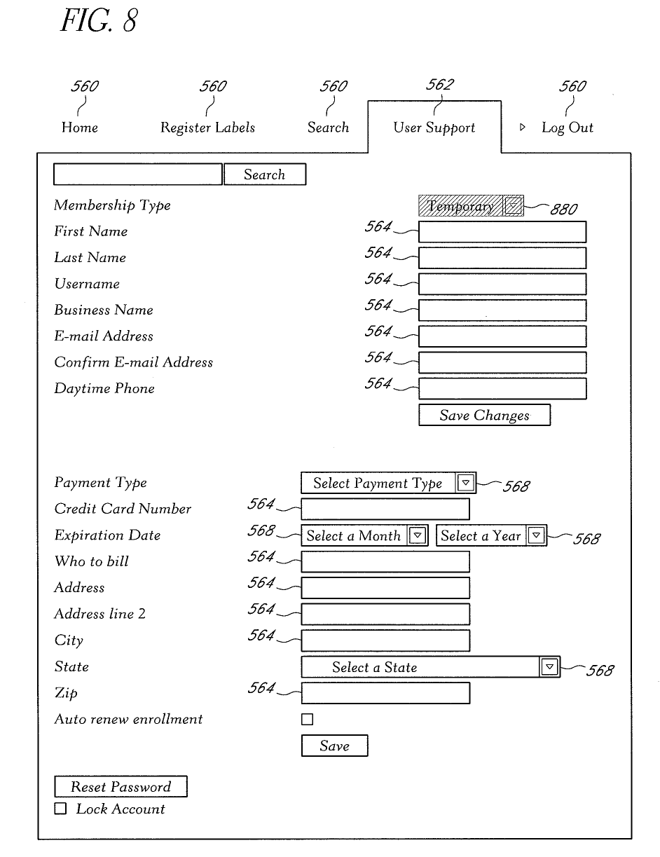

FIG. 8 illustrates a possible user support page for the representative website, application, or the like discussed herein. This page may allow a user to confirm or alter their account information, reset their password, and the like. As shown in FIG. 8, some fields may be unalterable by a user, such as the “Membership Type” that is greyed out indicating an inability to change it. In an embodiment, these items may only be altered by an administrator.

The barcodes 218 discussed above may also be used in embodiments for registering bottles or retrieving and/or altering information about a specific bottle. For example, in an embodiment, a system data entry point 106 may include a bar code scanner and functionality to populate the unique identifier or serial number 214 from the label into the field during registration. In at least an embodiment, scanning a bottle's barcode 218 may automatically bring up a registration screen, if the bottle has not been registered before, and/or bring up a summary or information review screen if the bottle has been previously registered (as shown in question box 438 in FIG. 4 and alternative paths starting with blocks 440 and 446). In an embodiment, the system may also have specific coding in the unique identifiers to indicate wine type, year, and the like, which may be populated automatically when a bar code is read. In some embodiments, the system may be programmed to identify certain unique identifier ranges as being sold or otherwise provided to a specific winery, for a specific type of wine or vintage, and/or the like. The system may, in such an embodiment, automatically complete parts of the registration information to make it easier and faster for a user to register one or more bottles. Additionally, a user who registers a large number of wines, such as a winery, may utilize a system that would allow partial or complete automatic registration. Such an entry system may include a conveyer belt or similar device, having a barcode reader and a digital camera attached to a data entry point 106. Bottles traveling along the conveyor may have their bar codes scanned and a picture of the bottle taken as they travel past the equipment. This information may then be used to help register the bottles, with or without the aide of a human operator. For example, in an embodiment, software on the data entry point 106 pay include character recognition software that analyzes the picture take of the wine bottle label to extract information such as winery, wine name, vintage, type, and/or the like.

Additionally, the disclosure herein contemplates a number of different payment scenarios. In some embodiments, the registrant of the bottle pays based on plans such as per bottle or finite set of bottles registered, by a periodic subscription to the service, and the like. In some embodiments, a user wishing to search the database of registered wines and/or edit an entry must pay. In some embodiments, some combination of fees from registrants, searchers, and entry editors are collected. In embodiments, high volume users may receive discounts or other incentives. In some embodiments, the labels may be sold to users with the registration and tracking capabilities provided free or at a relatively low cost.

While the discussion contained herein focuses on registering and tracking bottles of wine, the teachings are equally applicable to numerous other collectibles, particularly those that cannot easily be fully inspected without opening, altering or destroying the collectible nature of the item. Collectible items such as stamps and coins may utilize the registration and tracking aspects of the present disclosure to help verify genuineness of an item. This may be particularly well-suited to improving the value of items traded through internet auctions or other situations where a prospective purchaser may not be able to inspect the item prior to purchase. The present disclosure is also applicable to numerous other situations. One further example is the pharmaceutical industry. Some pharmaceuticals, for example, may be best if maintained under certain conditions such as refrigeration. In such cases, utilizing labels, systems, and methods disclosed herein, the manufacturer, prescribing doctors, and/or patients may be able to track the age and holders of certain packages of a given pharmaceutical, as well as determine if the package is a genuine product of a certain manufacturer. It may also be possible to determine if the package was transported and maintained under acceptable conditions.

Other embodiments will be apparent to those of ordinary skill in the art from the disclosure herein. Moreover, the described embodiments have been presented by way of example only, and are not intended to limit the scope of the disclosure. Indeed, the methods, systems, and devices described herein may be embodied in a variety of other forms without departing from the spirit thereof. Accordingly, other combinations, omissions, substitutions and modifications will be apparent to those of skill in the relevant fields in view of the disclosure herein. Thus, the present disclosure is not limited by the preferred embodiments, but is defined by reference to the appended claims. The accompanying claims and their equivalents are intended to cover forms or modifications as would fall within the scope and spirit of the disclosure.

What is claimed is:

1. A system for registering a product, the system comprising:
a label comprising:
a unique identifier; and
an environmental indicator;
wherein the label is adapted to attach to at least one of a product or a product container; and
a server capable of accepting and storing data regarding the at least one product or product container and associating the data with the unique identifier.

2. The system for registering a product of claim 1, wherein:
the server connects to a communications network to communicate with a data entry point, wherein the data entry point is capable of accepting the data regarding the at least one of a product or product container and forwarding it to the server for storage.

3. The system for registering a product of claim 2, wherein the server is capable of storing history data associated with the unique identifier.

4. The system for registering a product of claim 2, wherein the communications network is the internet.

5. The system for registering a product of claim 3, wherein the server is a web server.

6. The system for registering a product of claim 2, wherein the product container is a bottle and the product is wine.

7. The system for registering a product of claim 2, wherein the product is a collectable.

8. The system for registering a product of claim 2, wherein the product is a pharmaceutical and the label is adapted to attach to the product container.

9. The system for registering a product of claim 2, wherein the server includes auction capabilities.

10. The system for registering a product of claim 2, wherein:
the label comprises a security feature for hindering at least one of either tampering or copying.

11. The system for registering a product of claim 10, wherein the at least one security feature comprises a hologram.

12. The system for registering a product of claim 10, wherein the security feature comprises a tamper evident layer such that attempted removal of the label alters a visual appearance of the label.

13. A system for registering a product, the system comprising:
a label, adapted to be affixed to a product, the label including a unique identifier; and
a server capable of accepting and storing data regarding the product and associating the data with the unique identifier;
wherein the data capable of being stored includes history data that can aid in tracking alterations to previously entered data.

14. A product label comprising:
an information layer, having a front and back side;
an adhesive on the back side of the information layer;
an environmental indicator; and
a unique identifier contained on the information layer, wherein the unique identifier is capable of distinguishing an associated product container from any other product container and the unique identifier is adapted for entry into a product registration system capable of storing multiple records, each record having one unique identifier and data from the associated product container.

15. The product label of claim 14 wherein the associated product container is a wine bottle.

16. The product label of claim 14 further comprising a machine-readable element indicative of the unique identifier.

17. The product label of claim 16 wherein the machine-readable element is a bar code.

18. The product label of claim 16 further the machine-readable element is a radio frequency (RF ID) tag.

19. The product label of claim 14, wherein the adhesive significantly reduces the ability to remove the label from an associated product container without damage to the information layer.

20. The product label of claim 14 wherein the environmental indicator comprises a temperature indicator.

21. The product label of claim 14 wherein the environmental indicator comprises a humidity indicator.

22. The product label of claim 20 wherein the temperature indicator is irreversible.

23. The product label of claim 22 wherein the temperature indicator indicates a maximum temperature reached.

24. The product label of claim 22 wherein the temperature indicator indicates a minimum temperature reached.

25. The product label of claim 20 wherein the temperature indicator includes a time delay in changing such that it more accurately corresponds to a temperature experienced internal to an associated product container.

26. A method of registering a product, the steps of the method comprising:
identifying a unique label associated with a product or a product container, the label comprising a unique identifier and an environmental indicator;
communicating the unique identifier to a server;
associating information indicative of the product and the environmental indicator with the unique identifier; and
saving the unique identifier and associated information in a data record on the server.

27. The method of registering a product of claim 26 wherein the steps of communicating and associating occur through a remote data entry point.

28. The method of registering a product of claim 26 wherein the method further comprises the step of providing a verified password to the server prior to the saving step.

29. The method of registering a product of claim 26 wherein the product is wine and the information indicative of the product includes at least one from the group of:
a winery name;
a wine name;
a wine vintage;
a wine bottle owner information;
a purchase date;
a wine bottle distinguishing markings; and
a maximum temperature at which an associated wine bottle has been stored.

30. A computer-based method of registering and verifying a product, the steps of the method comprising:
accepting a unique identifier associated with a product from a user at a server;
creating a data record in a database associated with the server for storing information related to the product, wherein the data record is capable of maintaining history data to track changes to the data record;
accepting information indicative of the product at a server; and
storing the unique identifier and the information indicative of the product in the data record.

31. The computer-based method of registering and verifying a product of claim 30, the steps of the method further comprising:
accepting information requests with respect to a specified unique identifier from a viewer; and
providing to the viewer at least some of the information indicative of the product from the data record including the unique identifier corresponding to the specified unique identifier.

32. The computer-based method of registering and verifying a product of claim 30, the steps of the method further comprise altering at least some data stored in the data record.

33. The computer-based method of registering and verifying a product of claim 32, wherein the data record maintains both the original data and the altered data after the step of altering at least some data.

34. The computer-based method of registering and verifying a product of claim 30, wherein the steps of accepting a unique identifier and accepting information comprise communicating with a remote data entry point over a communications network.
